(19) United States
(12) Patent Application Publication
(10) Pub. No.: US 2018/0037203 A1
(43) Pub. Date: Feb. 8, 2018

(54) Hydraulic Control Apparatus and Brake System

(71) Applicant: Hitachi Automotive Systems, Ltd., Hitachinaka-shi, Ibaraki (JP)

(72) Inventors: Ryohei MARUO, Kawasaki-shi, Kanagawa (JP); Chiharu NAKAZAWA, Kawasaki-shi, Kanagawa (JP); Masaki MISUNO, Atsugi-shi, Kanagawa (JP)

(21) Appl. No.: 15/548,869

(22) PCT Filed: Feb. 3, 2016
(86) PCT No.: PCT/JP2016/053135

§ 371 Date: Aug. 4, 2017

(30) Foreign Application Priority Data
Feb. 6, 2015 (JP) 2015-021684

(51) Int. Cl. B60T 8/40; B60T 13/74; B60T 13/68

(52) U.S. Cl. CPC B60T 8/409; B60T 13/686; B60T 13/745

(57) ABSTRACT

An object of the present invention is to provide a hydraulic control apparatus and a brake system capable of preventing or cutting down a cost increase. According to one aspect of the present invention, a hydraulic control apparatus includes a hydraulic source provided inside a housing and configured to generate a hydraulic pressure in a hydraulic generation unit mounted on a wheel via an oil passage, a switching electromagnetic valve provided integrally in the housing and configured to be used to permit an inflow of brake fluid into a stroke simulator provided separately from the housing and configured to generate a reaction force of a brake pedal operation performed by a driver, and a control unit provided integrally in the housing and configured to be used to drive the hydraulic source and the switching electromagnetic valve.

### TECHNICAL FIELD

The present invention relates to a hydraulic control apparatus and a brake system of a hydraulic brake that applies a braking force to a vehicle.

### BACKGROUND ART

Conventionally, there has been known a technique discussed in PTL 1 as a hydraulic control apparatus. The technique discussed in this patent literature includes an input apparatus equipped with a master cylinder and a stroke simulator, a motor cylinder apparatus serving as a hydraulic source, and a control apparatus that controls a hydraulic pressure.

### CITATION LIST

### Patent Literature

PTL 1: Japanese Patent Application Public Disclosure No. 2012-106646

### SUMMARY OF INVENTION

### Technical Problem

However, the technique discussed in PTL 1 includes a solenoid valve provided to the input apparatus for switching activation of the stroke simulator, thereby necessitating establishment of an electric connection with the control apparatus, thus involving a possibility of leading to a cost increase accompanying handling of a harness. An object of the present invention is to provide a hydraulic control apparatus and a brake system capable of preventing or cutting down the cost increase.

### Solution to Problem

To achieve the above-described object, according to one aspect of the present invention, a hydraulic control apparatus includes a hydraulic source provided inside a housing and configured to generate a hydraulic pressure in a hydraulic generation unit mounted on a wheel via an oil passage, a switching electromagnetic valve provided integrally in the housing and configured to be used to permit an inflow of brake fluid into a stroke simulator provided separately from the housing and configured to generate a reaction force of a brake pedal operation performed by a driver, and a control unit provided integrally in the housing and configured to be used to drive the hydraulic source and the switching electromagnetic valve.

### Advantageous Effects of Invention

In other words, the switching electromagnetic valve for permitting the inflow of the brake fluid into the stroke simulator is provided on the hydraulic control apparatus side, which allows omission of the harness and the like required to be provided between the hydraulic control apparatus and the stroke simulator, thereby succeeding in preventing or cutting down the cost increase.

### BRIEF DESCRIPTION OF DRAWINGS

FIG. 1 is a system diagram illustrating a brake system according to a first embodiment together with a hydraulic circuit.

FIG. 2 is a perspective view of the brake system according to the first embodiment.

FIG. 3 is a cross-sectional view of a first unit according to the first embodiment.

FIG. 4 is a perspective view illustrating a front right side of a second unit according to the first embodiment.

FIG. 5 is a perspective view illustrating a front left side of the second unit according to the first embodiment.

FIG. 6 is a left side view of the second unit according to the first embodiment.

### DESCRIPTION OF EMBODIMENTS

### First Embodiment

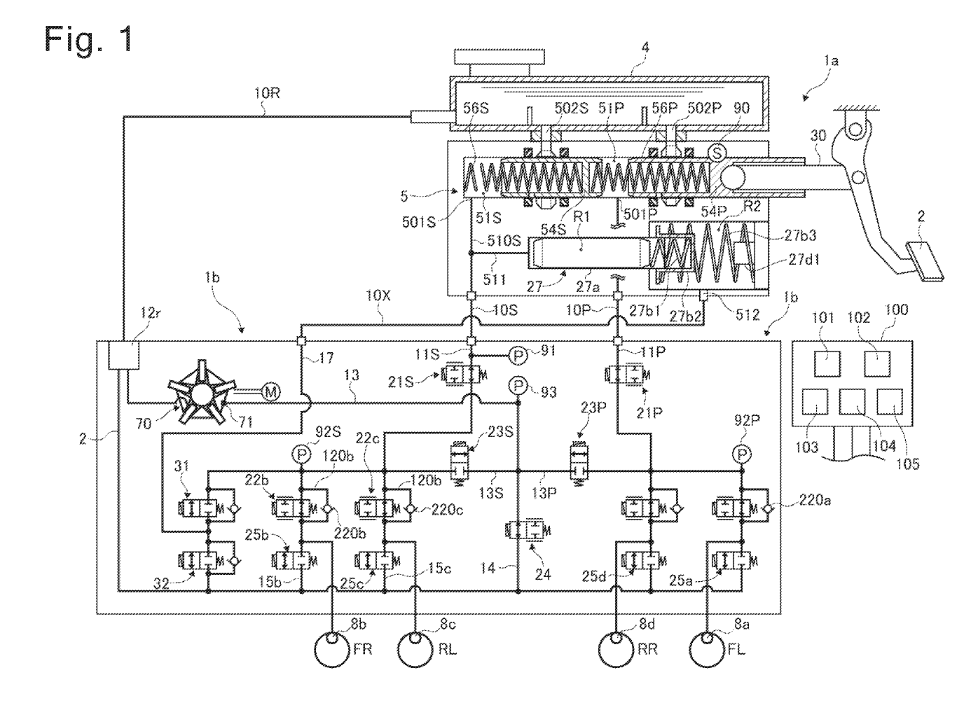

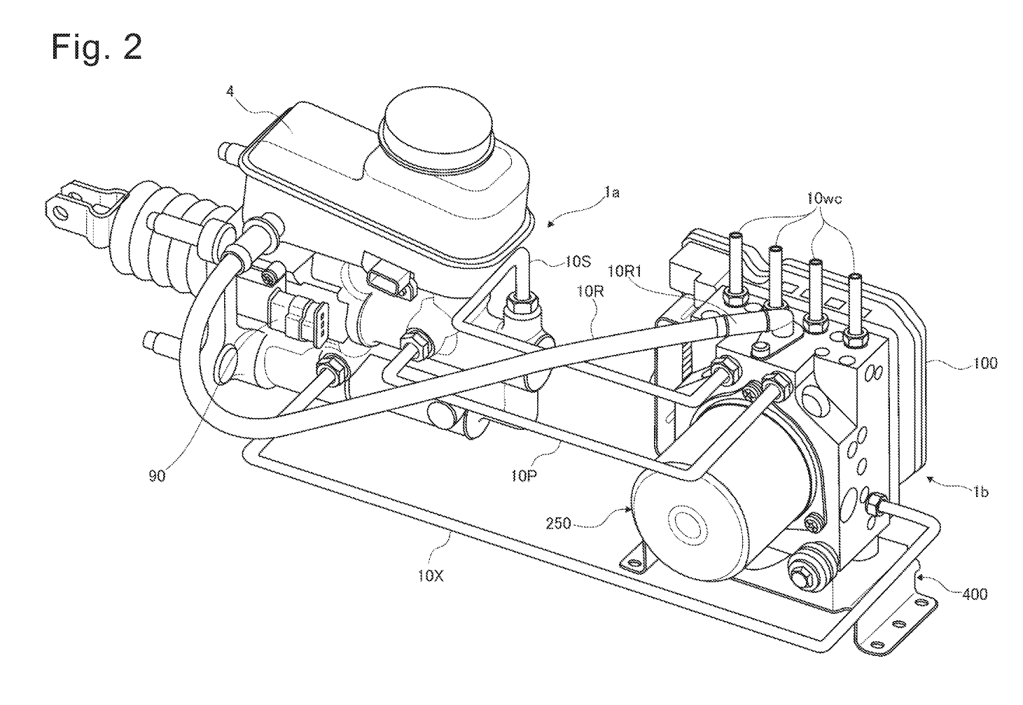

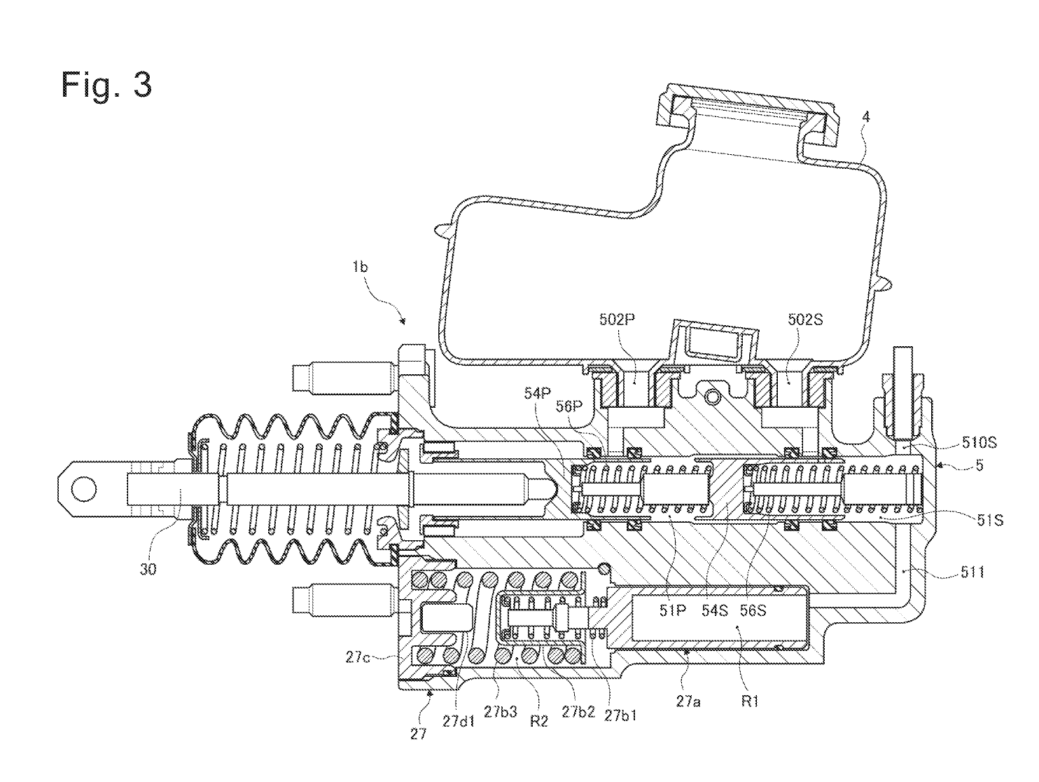

FIG. 1 schematically illustrates a configuration of a brake system according to a first embodiment together with a hydraulic circuit. FIG. 2 is a perspective view of the brake system according to the first embodiment. FIG. 3 is a cross-sectional view of a first unit according to the first embodiment. The brake system according to the first embodiment is applied to a brake system of an electric vehicle, such as a hybrid vehicle including an electric motor (a generator) besides an engine and an electric vehicle including only the electric motor (the generator) as a prime mover that drives wheels. Such an electric vehicle can carry out regenerative braking, which brakes the vehicle by converting a kinetic energy of the vehicle into electric energy with use of a regenerative braking apparatus including the motor (the generator). The brake system supplies brake fluid working as hydraulic fluid to a brake activation unit mounted on each of wheels FL to RR of the vehicle via a wheel cylinder pipe 10 wc to generate a brake hydraulic pressure (a wheel cylinder hydraulic pressure), thereby applying a hydraulic braking force to each of the wheels FL to RR.

The brake activation unit including a wheel cylinder 8 is a so-called-disk type brake device. The brake activation unit includes a brake disk and a caliper (a hydraulic brake caliper). The brake disk is a brake rotor that rotates integrally with a tire. The caliper is disposed with a predetermined clearance (a space, or a gap due to loose mounting) generated between the caliper and the brake disk, and includes a brake pad that generates the braking force by being displaced by the wheel cylinder hydraulic pressure into contact with the brake disk. The brake system 1 includes two brake pipe systems (a primary P system and a secondary S system). For example, a so-called X-split pipe configuration is employed as the brake piping method. The brake system 1 may employ another piping method, such as a front/rear split pipe configuration. Hereinafter, when a component provided in correspondence with the P system and a component provided in correspondence with the S system should be distinguished from each other, indices P and S will be added at the ends of the respective reference numerals.

The brake system includes a first unit 1a and a second unit 1b. The first unit 1a is physically connected to a brake pedal 2 operated by a driver. The second unit 1b controls brake hydraulic pressures in the wheel cylinders 8. The first unit 1a and the second unit 1b are connected via pipes or conduits (a connection pipe 10R, a primary pipe 10P, a secondary pipe 10S, and a backpressure chamber pipe 10x) (refer to FIG. 2). The first unit 1a includes the brake pedal 2, a reservoir tank (hereinafter referred to as a reservoir) 4, a master cylinder 5, and a stroke simulator 27. The brake pedal 2 serves as a brake operation member that receives an input of a brake operation performed by an operator (a driver). The reservoir 4 is a brake fluid source that stores the brake fluid therein, and is a low-pressure portion opened to an atmospheric pressure. The master cylinder 5 is connected to the brake pedal 2 and is also replenished with the brake fluid from the reservoir 4, and generates a brake hydraulic pressure (a master cylinder pressure) by being activated by the operation that the driver performs on the brake pedal 2. The stroke simulator 27 creates a pedal reaction force (a pedal reaction force and a pedal stroke amount) by an inflow of the brake fluid from the master cylinder 5 according to the brake operation performed by the driver. Details of the stroke simulator 27 will be described below. The second unit 1b includes a plurality of electromagnetic valves and the like, and an electronic control unit (hereinafter referred to as an ECU) 100. The plurality of electromagnetic valves and the like receive supply of the brake fluid from the reservoir 4 or the master cylinder 5, and generate the brake hydraulic pressure independently of the brake operation performed by the driver. The ECU 100 controls activation of this plurality of electromagnetic valves and the like, and a pump 70. Hereinafter, the various kinds of electromagnetic valves will be referred to as electromagnetic valves 20, when they are collectively referred to.

The first unit 1a does not include an engine negative-pressure booster that boosts the brake operation force by utilizing an intake negative pressure generated by an engine of the vehicle. A push rod 30 is rotatably connected to the brake pedal 2. The master cylinder 5 is a tandem-type master cylinder. The master cylinder 5 includes a primary piston 54P connected to the push rod 30 and a secondary piston 54S configured as a free piston as master cylinder pistons axially displaceable according to the brake operation performed by the driver. The primary piston 54P is provided with a stroke sensor 90 that detects the pedal stroke. A magnet for detection is provided at the piston, and a sensor main body is attached to an outer surface of the housing.

The second unit 1b is provided between the first unit 1a and the wheel cylinders 8. The second unit 1b includes the built-in pump 70, and performs control so as to be able to individually supply the master cylinder pressure or a control hydraulic pressure to each of the wheel cylinders 8. The second unit 1b includes a plurality of control valves as actuators for generating the control hydraulic pressure. The electromagnetic valves and the like perform opening/closing operations according to a control signal, thereby controlling a flow of the brake fluid. The second unit 1b can perform control of increasing the pressures in the wheel cylinders 8 with use of the hydraulic pressure generated by the pump 70 with the master cylinder 5 and the wheel cylinders 8 out of communication with each other. Further, the second unit 1b includes therein hydraulic sensors 91 to 93, which detect a discharge pressure of the pump 70 and the master cylinder pressure.

The pump 70 draws the brake fluid from the reservoir 4 and discharges the brake fluid toward the wheel cylinders 8 by being rotationally driven by a motor M. In the present embodiment, the pump 70 is embodied by a plunger pump including five plungers, which is excellent in terms of a noise and vibration performance and the like. The pump 70 is used in common by both of the S and P systems. The pump 70 is driven by the single motor M. The motor M may be a brushless motor or may be a brushed motor.

Detection values transmitted from the stroke sensor 90 and the hydraulic sensors 91 to 93, and information regarding a running state transmitted from the vehicle are input to the ECU 100. The ECU 100 controls each of the actuators in the second unit 1b based on a program installed therein. More specifically, the ECU 100 controls the opening/closing operations of the electromagnetic valves that switch communication states of oil passages, and the number of revolution(s) of the motor M that drives the pump 70 (i.e., a discharge amount of the pump 70). By this operation, the brake system according to the first embodiment realizes boosting control for reducing a required brake operation force, anti-lock brake control (hereinafter referred to as ABS) for preventing or reducing a slip of a wheel that might be caused when the vehicle is braked, control of a motion of the vehicle (brake control for vehicle behavior stabilization control such as electronic stability control, which will be hereinafter referred to as motion control), automatic brake control such as adaptive cruise control, regenerative cooperative brake control that controls the wheel cylinder hydraulic pressure so as to achieve a target deceleration (a target braking force) by collaborating with the regenerative brake, and the like. In the boosting control, the ECU 100 drives the second unit 1b with use of the discharge pressure of the pump 70 as a hydraulic source, when the driver performs the brake operation. In the boosting control, the ECU 100 creates a higher wheel cylinder hydraulic pressure than the master cylinder pressure, thereby generating a hydraulic braking force for compensating for insufficiency of the brake operation force input by the driver. The boosting control allows the brake system to exert a boosting function that assists the brake operation. In other words, the brake system assists the brake operation force by activating the pump 70 of the second unit 1b instead of the engine negative-pressure booster. In the regenerative cooperative brake control, the ECU 100 generates a hydraulic braking force by which a regenerative braking force generated by the regenerative braking apparatus is insufficient to, for example, achieve a braking force requested by the driver.

The master cylinder 5 is a first hydraulic source connected to the wheel cylinders 8 via the primary pipe 10P, the secondary pipe 10S, and first oil passages 11, which will be described below, and capable of increasing the wheel cylinder hydraulic pressures. The master cylinder 5 can increase the pressures in wheel cylinders 8a and 8d via an oil passage (a first oil passage 11P) in the P system with use of a master cylinder pressure generated in a first fluid chamber 51P. At the same time, the master cylinder 5 can increase the pressures in wheel cylinders 8b and 8c via a first oil passage 11S in the S system with use of a master cylinder pressure generated in a second fluid chamber 51S. The pistons 54P and 54S in the master cylinder 5 are inserted axially displaceably along an inner peripheral surface of a bottomed cylindrical cylinder. The cylinder includes a discharge port (a supply port) 501 and a replenishment port 502 for each of the P and S systems. The discharge port 501 is provided so as to be able to connect to the second unit 1b to communicate with the wheel cylinders 8. The replenishment port 502 is connected to the reservoir 4 and is in communication with the reservoir 4. A coil spring 56P as a return spring is set in the first fluid chamber 51P between the pistons 54P and 54S in a pressed and compressed state. A coil spring 56S is set in the second fluid chamber 51S between the piston 54S and an axial end of the cylinder in a pressed and compressed state. The discharge ports 501 are normally or constantly opened to the first and second fluid chambers 51P and 51S.

A primary oil passage 510P connected to the primary pipe 10P and a secondary oil passage 510S connected to the secondary pipe 10S are connected to the discharge ports 501, respectively. A first simulator oil passage 511 connected to a main chamber R1 of the stroke simulator 27 is connected to the secondary oil passage 510S. An auxiliary chamber (a backpressure chamber) R2 of the stroke simulator 27 includes a backpressure chamber port 512 connected to the backpressure chamber pipe 10x.

In the following description, a brake hydraulic circuit of the second unit 1b will be described with reference to FIG. 1. Members corresponding to the individual wheels FL to RR will be distinguished from one another if necessary, by indices a to d added at the ends of reference numerals thereof, respectively. The second unit 1b includes the first oil passages 11, normally opened shut-off valves 21, normally opened pressure-increase valves (hereinafter referred to as SOL/V INs) 22, an intake oil passage 12, a discharge oil passage 13, a normally-closed communication valve 23P, a normally-closed communication valve 23S, a first pressure-reduction oil passage 14, a normally-opened pressure adjustment valve 24, second pressure-reduction oil passages 15, normally-closed pressure-reduction valves 25, and a second simulator oil passage 17. The first oil passages 11 connect the primary pipe 10P and the secondary pipe 10S, and the wheel cylinders 8 to each other. The shut-off valves 21 are provided in the first oil passages 11. The SOL/V INs 22 are provided on the wheel cylinder 8 side in the first oil passages 11 with respect to the shut-off valves 21 in correspondence with the individual wheels FL to RR (in oil passages 11a to 11d), respectively. The intake oil passage 12 connects a fluid pool 12r provided at an intake portion of the pump 70 and the pressure-reduction oil passages 15, which will be described below, to each other. The discharge oil passage 13 connects a portion in the first oil passages 11 between the shut-off valves 21 and the SOL/V INs 22, and a discharge portion 71 of the pump 70 to each other. The communication valve 23P is provided in a discharge oil passage 13P connecting a downstream side of the discharge oil passage 13 and the first oil passage 11P in the P system to each other. The communication valve 23S is provided in a discharge oil passage 13S connecting the downstream side of the discharge oil passage 13 and the first oil passage 11S in the S system to each other. The first pressure-reduction oil passage 14 connects a portion between a discharge oil passage 13P and the communication valves 23P and 23S, and the intake oil passage 12 to each other. The pressure adjustment valve 24 is provided in the first pressure-reduction oil passage 14. The second pressure-reduction oil passages 15 connect a wheel cylinder 8 side in the first oil passages 11 with respect to the SOL/V INs 22, and the intake oil passage 12 to each other. The pressure-reduction valves 25 serve as second pressure-reduction valves provided in the second pressure-reduction oil passages 15. The second simulator oil passage 17 connects the backpressure chamber pipe 10x and a portion in the first oil passage 11S between the shut-off valve 21S and the SOL/V INs 22b and 22c, and the intake oil passage 12 to each other via a stroke simulator IN valve 31 and a stroke simulator OUT valve 32.

In the pump 70, the fluid pool 12r is provided at a portion where the connection pipe 10R extending from the reservoir 4 is connected to the intake oil passage 12 of the pump 70. The discharge oil passages 13P and 13S form communication passages connecting the first oil passage 11P in the P system and the first oil passage 11S in the S system to each other. The pump 70 is connected to the wheel cylinders 8a to 8d via the above-described communication passages (the discharge oil passages 13P and 13S) and the first oil passages 11P and 11S. The pump 70 serves as a second hydraulic source capable of increasing the wheel cylinder hydraulic pressures by discharging the brake fluid to the above-described communication passages (the discharge oil passages 13P and 13S). At least one of the shut-off valves 21, the SOL/V INs 22, the communication valve 23P, the pressure adjustment valve 24, and the pressure-reduction valves 25 of each of the systems (the SOL/V INs 22 and the pressure adjustment valve 24 in the present embodiment) is a proportional control valve, an opening degree of which is adjusted according to a current supplied to a solenoid. The other valves are ON/OFF valves, opening/closing of which is controlled to be switched between two values, i.e., switched to be either opened or closed. The proportional control valve can also be employed as the above-described other valves.

The shut-off valves 21 are provided in the first oil passages 11P and 11S. Bypass oil passages 120 are provided in parallel with the first oil passages 11 by bypassing the SOL/V INs 22. Further, the bypass oil passages 120 include check valves 220, which permit only a flow of the brake fluid from the wheel cylinder 8 side to the master cylinder 5 side. The hydraulic sensor 91 is provided on the master cylinder side of the first oil passages 11 with respect to the shut-off valves 11S. The hydraulic sensor 91 detects a hydraulic pressure at this portion (a hydraulic pressure in the stroke simulator 27, and the master cylinder pressure). The hydraulic sensors 92 are provided between the shut-off valves 21 and the SOL/V INs 22 in the first oil passages 11. The hydraulic sensors 92 detect hydraulic pressures at these portions (the wheel cylinder hydraulic pressures). The hydraulic sensor 93 is provided between the discharge oil passage 13P and the communication valve 23. The hydraulic sensor 93 detects a hydraulic pressure at this portion (the discharge pressure of the pump).

Now, the details of the stroke simulator 27 of the first unit 1a will be described with reference to FIGS. 1 to 3. The stroke simulator 27 includes a piston 27a, a first spring 27b1, a retainer member 27b2, and a second spring 27b3. The piston 27a is disposed axially displaceably in a chamber R while dividing an inside of the chamber R into two chambers (the main chamber R1 and the auxiliary chamber R2). The spring 27b1 is an elastic member set in the auxiliary chamber R2 in a pressed and compressed state, and constantly biasing the piston 27a toward one side where the main chamber R1 is located (in a direction for reducing a volume of the main chamber R1 and increasing a volume of the auxiliary chamber R2). The retainer member 27b2 holds the first spring 27b1. The second spring 27b3 is an elastic member constantly biasing the retainer member 27b2 toward the main chamber R1 side. A damper 27d1 is provided at a spring member 27c for the purpose of improving a pedal feeling (refer to FIG. 3). Hereinafter, the first spring 27b1 and the second spring 27b3 will be collectively referred to as the springs 27b.

When the stroke simulator IN valve 31 and the stroke simulator OUT valve 32 are respectively controlled in closing directions with the shut-off valves 21 in the second unit 1b controlled in opening directions, the brake system (the first oil passages 11) connecting the first and second fluid chambers 51P and 51S of the master cylinder 5 and the wheel cylinders 8 to each other creates the wheel cylinder hydraulic pressures by the master cylinder pressure generated with use of the force of pressing the pedal, thereby realizing pressing force brake (non-boosting control). On the other hand, the brake system connecting the second fluid pressure 51S of the master cylinder 5 and the wheel cylinders 8 to each other with the shut-off valves 21 controlled in closing directions, the stroke simulator IN valve 31 controlled in an opening direction, and the stroke simulator OUT valve 32 controlled in the closing direction creates the wheel cylinder hydraulic pressure with use of the brake hydraulic pressure flowing out of the auxiliary chamber R2 reduced in volume according to the displacement of the piston 27a of the stroke simulator 27, thereby realizing a second pressure force brake. Further, when the stroke simulator valve IN valve 31 and the stroke simulator OUT valve 32 are controlled in the closing direction and the opening direction, respectively, with the shut-off valves 21 controlled in the closing directions, the brake system connecting the reservoir 4 and the wheel cylinders 8 to each other (the intake oil passage 12, the discharge oil passage 13, and the like) creates the wheel cylinder hydraulic pressures by the hydraulic pressure generated with use of the pump 70, and forms a so-called brake-by-wire system that realizes the boosting control, the regenerative cooperative control, and the like. The brake system may be configured to switch the brake control to the boosting control or the regenerative cooperative control after the second pressing force brake.

As illustrated in the cross-section of FIG. 3, the secondary oil passage 510S is connected to the first fluid chamber 51S of the master cylinder 5, and the first simulator oil passage 511 connected to the main chamber R1 of the stroke simulator 27 is also connected to the first fluid chamber 51S of the master cylinder 5. In this manner, the first simulator oil passage 511 is formed inside the first unit 1a, which eliminates a necessity of connecting the second unit 1b side and the main chamber R1 to each other, thereby preventing or cutting down a cost increase accompanying an increase in the pipes. With the shut-off valves 21 controlled in the closing directions to block the communication between the master cylinder 5 and the wheel cylinders 8, the stroke simulator 27 causes at least the brake fluid flowing out of the first fluid chamber 51S of the master cylinder 5 to be introduced into the main chamber R1 via the first simulator oil passage 511, thereby creating the pedal reaction force. With the shut-off valve 21S closed to block the communication between the master cylinder 5 and the wheel cylinders 8, and the stroke simulator OUT valve 32 opened to establish the communication between the master cylinder 5 and the stroke simulator 27, the stroke simulator 27 introduces and discharges the brake fluid from the master cylinder 5, thereby creating the pedal reaction force, when the driver performs the brake operation (presses the brake pedal 2 or releases the pressed brake pedal 2).

More specifically, when a hydraulic pressure (the master cylinder pressure) equal to or higher than a predetermined pressure is applied to a pressure-receiving surface of the piston 27a in the main chamber R1, the piston 27a is axially displaced toward the auxiliary chamber R2 side while pressing and compressing the spring 27b, thereby increasing the volume of the main chamber R1. As a result, the brake fluid is delivered from the secondary oil passage 510S of the master cylinder 5 into the main chamber R1 via the first simulator oil passage 511. At the same time, the brake fluid is discharged from the auxiliary chamber R2 into the intake oil passage 12 via the backpressure chamber pipe 10x and the second simulator oil passage 17 in the second unit 1b. When the pressure in the main chamber R reduces to lower than the predetermined pressure, the piston 27a is returned to an initial position due to the biasing force (an elastic force) of the spring 27b. The stroke simulator 27 introduces therein the brake fluid from the master cylinder 5 in this manner, thereby simulating hydraulic stiffness of the wheel cylinders 8 to imitate a feeling that the driver would have when pressing the pedal.

In this manner, the electromagnetic valve and the like are not provided in the first unit 1a, and the stroke simulator IN valve 31 and the stroke simulator OUT valve 32 for switching the activation of the stroke simulator 27 are provided in the second unit 1b. Therefore, the present embodiment does not require a controller for driving the electromagnetic valve in the first unit 1a and a wiring for controlling the electromagnetic valve between the first unit la and the second unit 1b. Therefore, the present embodiment can reduce the cost. Further, when the stroke simulator 27 in the first unit 1a and the second unit 1b are connected as the pipe, the main chamber R1 of the stroke simulator 27 and the second unit 1b are not connected to each other, and only the backpressure chamber as the auxiliary chamber R2 and the second unit 1b are connected to each other via the backpressure chamber pipe 10x. Therefore, the present embodiment allows the activation of the stroke simulator 27 to be switched without requiring a plurality of pipes, thereby succeeding in reducing the cost.

The ECU 100 forms a hydraulic control unit that activates the pump 70, the electromagnetic valves, and the like based on various kinds of information to control the hydraulic pressures in the wheel cylinders 8. The ECU 100 includes a brake operation amount detection unit 101, a target wheel cylinder hydraulic pressure calculation unit 102, a pressing force brake creation unit 103, a boosting control unit 104, and a boosting control switching unit 105. The brake operation amount detection unit 101 detects a displacement amount (the pedal stroke) of the brake pedal 2 as the brake operation amount upon receiving the input of the value detected by the stroke sensor 90. The target wheel cylinder hydraulic pressure calculation unit 102 calculates a target wheel cylinder hydraulic pressure. More specifically, the target wheel cylinder hydraulic pressure calculation unit 102 calculates the target wheel cylinder hydraulic pressure that realizes a predetermined boosting rate, i.e., an ideal characteristic about a relationship between the pedal stroke and a brake hydraulic pressure requested by the driver (a vehicle deceleration G requested by the driver) based on the detected pedal stroke. Further, in the regenerative cooperative brake control, the target wheel cylinder hydraulic pressure calculation unit 102 calculates the target wheel cylinder hydraulic pressure in relation to the regenerative braking force. More specifically, the target wheel cylinder hydraulic pressure calculation unit 102 calculates such a target wheel cylinder hydraulic pressure that a sum of the regenerative braking force input from a control unit of the regenerative braking apparatus and a hydraulic braking force corresponding to the target wheel cylinder hydraulic pressure can satisfy the vehicle deceleration requested by the driver. In the motion control, the target wheel cylinder hydraulic pressure calculation unit 102 calculates the target wheel cylinder hydraulic pressure for each of the wheels FL to RR so as to, for example, realize a desired state of the vehicle motion based on a detected amount of a state of the vehicle motion (a lateral acceleration or the like).

The pressing force brake creation unit 103 is configured to prohibit the stroke simulator 27 from functioning by controlling the shut-off valves 21 in the opening direction and the stroke simulator OUT valve 32 in the closing direction, thereby realizing the pressing force brake that creates the wheel cylinder hydraulic pressures from the master cylinder pressure. The boosting control unit 104 controls the shut-off valves 21 in the closing direction to thus make the second unit 1b ready to create the wheel cylinder hydraulic pressures by the pump 70, thereby performing the boosting control. The boosting control unit 104 controls each of the actuators to realize the target wheel cylinder hydraulic pressure. Further, the ECU 100 closes the stroke simulator IN valve 31 and controls the stroke simulator OUT valve 32 in the opening direction, thereby causing the stroke simulator 27 to function.

The boosting control switching unit 105 controls the activation of the master cylinder 5 to switch the pressing force brake and the boosting control based on the calculated target wheel cylinder hydraulic pressure. More specifically, upon detection of a start of the brake operation by the brake operation amount detection unit 101, the boosting control switching unit 105 causes the pressing force brake creation unit 103 to create the wheel cylinder hydraulic pressures if the calculated target wheel cylinder hydraulic pressure is equal to or lower than a predetermined value (for example, corresponding to a maximum value of the vehicle deceleration G that would be generated when the vehicle is normally braked without being suddenly braked). On the other hand, the boosting control switching unit 105 causes the boosting control unit 104 to create the wheel cylinder hydraulic pressures if the target wheel cylinder hydraulic pressure calculated at the time of the operation of pressing the brake exceeds the above-described predetermined value. Further, the boosting control switching unit 105 can also switch the brake control so as to apply the second pressing force brake to create the wheel cylinder hydraulic pressures, and then create the wheel cylinder hydraulic pressures by the boosting control unit 104 after that, when detecting the brake pressing operation state and detecting a sudden braked state.

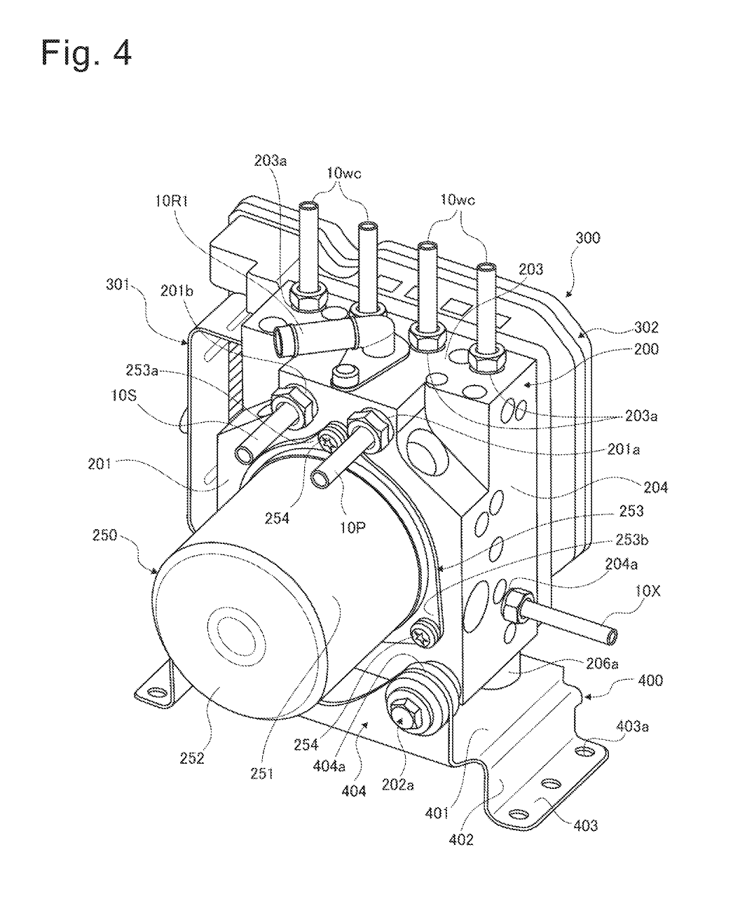

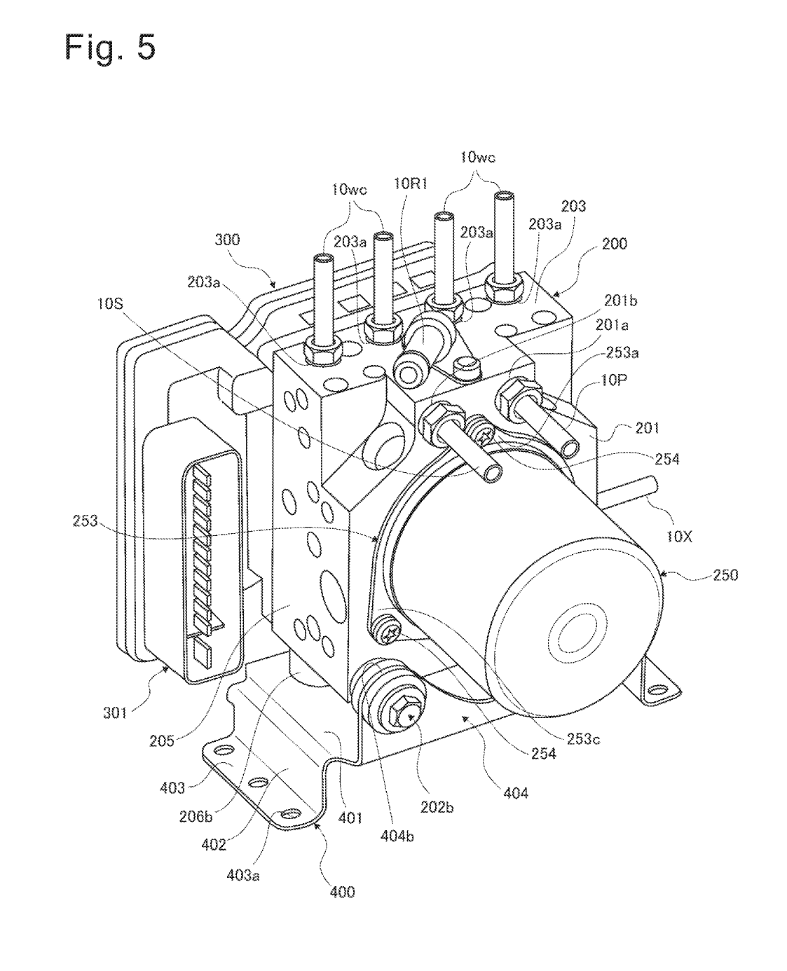

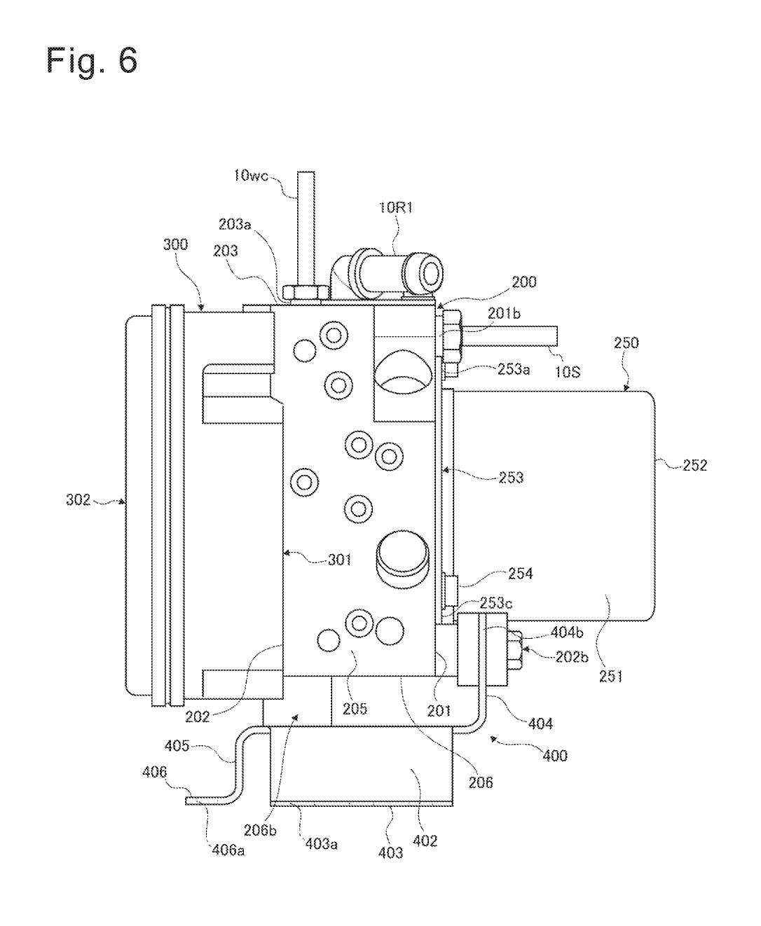

Next, a configuration of the second unit 1b will be described. FIG. 4 is a perspective view illustrating a front right side of the second unit according to the first embodiment. FIG. 5 is a perspective view illustrating a front left side of the second unit according to the first embodiment. FIG. 6 is a left side view of the second unit according to the first embodiment. The second unit 1b includes a housing 200, a control unit housing 300, and a mount 400. The housing 200 is made of an aluminum alloy block and contains the electromagnetic valves 20 and the pump 70 therein. The control unit housing 300 is made of a resin material and contains the ECU 100 therein. The mount 400 supports these housing 200 and control unit housing 300 on the vehicle body side.

The housing 200 includes a first surface 201, a second surface 202 (refer to FIG. 6), a third surface 203, a fourth surface 204, a fifth surface 205, and a sixth surface 206 (refer to FIG. 6). The second surface 202 is located opposite from the first surface 201. The third surface 203 is continuous from the first and second surfaces 201 and 202. The fourth surface 204 is continuous from the first, second, and third surfaces 201, 202, and 203. The fifth surface 205 is located opposite from the fourth surface 204. The sixth surface 206 is located opposite from the third surface 203. A motor housing 250 containing the motor M for driving the pump 70 therein is attached to the first surface 201. Further, master cylinder connection ports 201a and 201b connected to the primary pipe 10p and the secondary pipe 10S, respectively, are formed on a portion of the first surface 201 that is located above the motor M when the second unit 1b is mounted on the vehicle. Further, the housing 200 includes front-side mount pins 202a and 202b fixed to the mount 400 on the first surface 201 and a lower position located on an opposite side from the master cylinder connection port 201a via a center of a rotation of the motor M.

The motor housing 250 is a bottomed cylindrical member, and includes a cylindrical portion 251, a bottom portion 252, and a flange portion 253. The cylindrical portion 251 contains therein, for example, a rotor and a stator of the motor M on an inner periphery thereof. The bottom portion 252 closes one side of the cylindrical portion 251. The flange portion 253 has an increased diameter to allow the motor housing 250 to be attached to the first surface 201 side. The flange portion 253 includes first, second, and third flange portions 253a, 253b, and 253c for attaching the motor housing 250 to the first surface 201 with use of bolts 254. The first flange portion 253a is provided at a position overlapping the center of the rotation of the motor M and on an upper side as viewed from a top surface when the second unit 1b is mounted on the vehicle. Further, the first flange portion 253a is provided between the master cylinder connection ports 201a and 201b as viewed from a horizontal direction, and is disposed in such a manner that a line passing through lower ends of the master cylinder connection ports 201a and 201b overlaps the first flange portion 253a, thereby achieving a reduction in the size. The second flange portion 253b and the third flange portion 253c are provided at positions sandwiching the first flange portion 253a and on a lower side as viewed from the top surface when the second unit 1b is mounted on the vehicle. The front-side mount pins 202a and 202b are disposed in such a manner that respective centers of the pins are located on lower sides and outer sides with respect to centers of the bolts of the second flange portion 253b and the third flange portion 253c, respectively. Therefore, The second unit 1b can be stably supported due to the support based on the two points, and can also be stably supported due to an increase in a distance between the supporting points.

The control unit housing 300 is disposed on the second surface 202. The control unit housing 300 contains the ECU 100 therein, and also includes a controller portion 302 covering various kinds of electromagnetic valves. Further, the control unit housing 300 includes a connector portion 301 provided on a fifth surface 205 side of the controller portion 302 and on an outer position with respect to the housing 200 as viewed from a direction along a rotational axis of the motor. The connector portion 301 is formed in such a manner that a connection is completed by insertion of a connector from the direction along the rotational axis of the motor. The connector portion 301 electrically connects the external apparatus or the stroke sensor 90 and the ECU 100 to each other.

The third surface 203 is a top surface when the second unit 1b is mounted on the vehicle. Wheel cylinder pipe ports 203a, to which the wheel cylinder pipes 10wc connecting the wheel cylinders 8 and the second unit 1b to each other are connected, are provided on the third surface 203. The wheel cylinder pipes 10wc are disposed side by side at positions closer to the second surface 202 than to the first surface 201. Further, an intake port 10R1 connected to the reservoir 4 via the connection pipe 10R is formed on the third surface 203. The intake port 10R1 is provided at a central portion in a direction in which the wheel cylinder pipes 10wc are disposed side by side and at a position closer to the first surface 201 than the wheel cylinder pipes 10wc are. Therefore, the present embodiment can realize a layout utilizing the space in the third surface 203, thereby achieving the reduction in the size.

The fourth surface 204 is a side surface when the second unit 1b is mounted on the vehicle. A backpressure chamber port 204a connected to the backpressure chamber pipe 10x is formed at a lower portion of the fourth surface 204. An obstacle such as the connector portion 301 provided on the fifth surface 205 side is not provided on the fourth surface 204 side, so that the backpressure chamber pipe 10x can be easily connected. In other words, a port or the like, such as the backpressure chamber port 204a, is not formed on the fifth surface 205, which facilitates a connection when the connector is connected to the connector portion 301. The sixth surface 206 is a bottom surface when the second unit 1b is mounted on the vehicle. The sixth surface 206 includes two lower-side mount pins 206a and 206b fixed to the mount 400.

The mount 400 includes a first mount portion 401 facing the sixth surface 206. The lower-side mount pin 206b is fixed to the first mount portion 401 via an insulator, and absorbs a vibration between the second unit 1b and the first mount portion 401. The mount 400 includes leg portions 402 and flange portions 403 on sides of the first mount portion 402. The leg portions 402 are formed by being bent downward from both the sides, respectively. The flange portions 403 are formed at lower ends of the leg portions 402, and are fixed to the vehicle side. Three vehicle fixation bolt holes 403a, through which bolts for fixing the flange portion 403 to the vehicle side are inserted, are formed at each of the flange portions 403 side by side in the direction along the rotational axis of the motor. The mount 400 includes a leg portion 405 and a flange portion 406 on the second surface 202 side of the first mount portion 401. The leg portion 405 is formed by being bent downward. The flange portion 406 is formed at a lower end of the leg portion 405, and is fixed to the vehicle side. Vehicle fixation bolt holes 406a, through which bolts for fixing the flange portion 406 to the vehicle side, are provided at the flange portion 406.

The mount 400 includes a front-side support surface 404 on the first surface 201 side of the first mount portion 401. The front-side support surface 404 is formed by being bent toward one side where the cylindrical portion 251 of the motor housing 250 is located, and is curved along a shape of the cylindrical portion 251. The mount 400 includes fixation portions 404a and 404b on both ends of the front-side support surface 404. The fixation portions 404a and 404b fix the front-side mount pins 202a and 202b via insulators. Due to this configuration, the mount 400 absorbs a vibration between the second unit 1b and the front-side support surface 404. In this manner, the second unit 1b is supported at the four lower and front portions, which allows the second unit 1b to be stably held.

[Advantageous Effects of First Embodiment]

In the following description, advantageous effects of the brake system according to the first embodiment will be listed.

(1) The hydraulic control apparatus includes the housing 200 including the oil passage formed therein, the pump 70 (a hydraulic source) provided inside the housing 200 and configured to generate the hydraulic pressure in the wheel cylinder 8 (a hydraulic generation unit) mounted on the wheel via the oil passage, the stroke simulator IN valve 31 and/or the stroke simulator OUT valve 32 (a switching electromagnetic valve) provided integrally in the housing 200 and configured to be used to permit the inflow of brake fluid into the stroke simulator 27 provided separately from the housing 200 and configured to generate the reaction force of the brake pedal operation performed by the driver, and the ECU 100 (a control unit) provided integrally in the housing 200 and configured to be used to control drive the pump 70, and the stroke simulator IN valve 31 and/or the stroke simulator OUT valve 32.

Therefore, the first embodiment can omit the harness between the stroke simulator 27 and the ECU 100 that is required in the case where the stroke simulator IN valve 31 and/or the stroke simulator OUT valve 32 is/are provided on the stroke simulator 27 side, thereby preventing or cutting down the cost increase. Further, the first embodiment can also prevent or reduce an influence of radiation noise due to the omission of the harness.

(2) The hydraulic control apparatus described in the above-described item (1) further includes the backpressure chamber pipe 10x (a first oil passage) at the housing 200. The backpressure chamber pipe 10x is configured to supply the brake fluid flowing out of the auxiliary chamber R2 (a backpressure chamber) of the stroke simulator 27 to the stroke simulator IN valve 31 and/or the stroke simulator OUT valve 32.

Therefore, the first embodiment does not require the provision of the pipe connecting the main chamber R1 of the stroke simulator 27 and the second unit 1b to each other, thereby succeeding in reducing the cost due to the reduction in the pipes.

(3) The hydraulic control apparatus described in the above-described item (2) further includes the backpressure chamber port 204a (a connection port) at the housing 200. The backpressure chamber port 204a is connected to the backpressure pipe 10x and the oil passage connected to the stroke simulator 27.

Therefore, the first embodiment can connect the stroke simulator 27 and the stroke simulator IN valve 31 and/or the stroke simulator OUT valve 32 in the second unit 1b to each other via simple piping.

In the hydraulic control apparatus described in the above-described item (1), the housing 200 includes the first surface 201 to which the motor M configured to drive the pump 70 is attached, the second surface 202 located opposite from the first surface 201 and having the ECU 100 disposed thereon, the third surface 203 formed continuously from the first surface 201 and the second surface 202, and the fourth surface 204 formed continuously from the first surface 201, the second surface 202, and the third surface 203. The wheel cylinder pipe port 203a (a pipe port) to which the wheel cylinder pipe 10wc (a pipe) leading to the wheel cylinder 8 is connected is formed on the third surface 203. The backpressure chamber port 204a is formed on the fourth surface 204.

The wheel cylinder pipe 10wc and the backpressure chamber port 204a are disposed so as to be distributed on different surfaces, and therefore the first embodiment can prevent or cut down the increase in the size of the housing.

(5) The hydraulic control apparatus described in the above-described item (4) further includes the connector portion 301 (a connector) configured to electrically connect the ECU 100 to an external apparatus, and the fifth surface 205 located opposite from the fourth surface 204. The connector portion 301 is provided on the one side where the fifth surface 205 is located.

The connector portion 301, the port, and the like are not provided on the fifth surface 205, and therefore the first embodiment can improve workability when a wiring is connected to the connector portion 301.

(6) The hydraulic control apparatus described in the above-described item (5) further includes the sixth surface 206 located opposite from the third surface 203, and the mount 400 provided on the sixth surface 206. The mount 400 is configured to be used to fix the housing 200 to the vehicle.

Therefore, the functions can be distributed to the individual surfaces, and therefore the first embodiment can prevent or cut down the increase in the size of the housing 200.

(7) The hydraulic control apparatus described in the above-described item (4) further includes the connection pipe 10R (an intake oil passage) connecting the reservoir 4 and the housing 200 to each other. The reservoir 4 stores the brake fluid. The pump 70 draws the brake fluid from the reservoir 4. The third surface 203 is configured so as to become the top surface when the hydraulic control apparatus is mounted on the vehicle, and is provided with the intake port 10R1 connected to the connection pipe 10R.

Therefore, the first embodiment allows the wheel cylinder pipe 10wc and the connection pipe 10R to be provided on the third surface 203 that will become the top surface, thereby contributing to improvement of the workability of the pipe connection.

(8) The hydraulic control apparatus described in the above-described item (4) further includes the connection pipe 10R connecting the reservoir 4 and the housing 200 to each other. The reservoir 4 stores the brake fluid that the pump 70 draws from the reservoir 4. The wheel cylinder pipe port 203a includes the plurality of wheel cylinder pipe ports 203a formed along the longitudinal direction of the third surface 203. The intake port 10R1 is formed closer to the first surface 201 than the wheel cylinder pipe ports 203a are.

The wheel cylinder pipe ports 203a and the intake port 10R1 are disposed offset from each other, and therefore the first embodiment can realize an efficient layout of the ports and the like, thereby preventing or cutting down the increase in the size of the housing 200.

(9) In the hydraulic control apparatus described in the above-described item (8), the master cylinder connection port 201a or 201b to which the master cylinder pipe 10p or 10S connected to the master cylinder 5 is connected is formed on the first surface 201.

Therefore, the functions can be distributed to the individual surfaces, and therefore the first embodiment can prevent or cut down the increase in the size of the housing 200.

(10) In the hydraulic control apparatus described in the above-described item (1), the front-side mount pin 202a or 202b (a second mount portion) for fixing the housing 200 to the vehicle is provided on the first surface 201.

Therefore, the functions can be distributed to the individual surfaces, and therefore the first embodiment can prevent or cut down the increase in the size of the housing 200.

(11) In the hydraulic control apparatus described in the above-described item (10), the front-side mount pin 202a or 202b includes the plurality of front-side mount pins.

Therefore, the first embodiment can stably hold the housing 200.

In the following description, technical ideas recognizable from the above-described embodiment will be listed.

(12) A hydraulic control apparatus includes a housing including a plurality of oil passages formed therein, a connection port formed at the housing and connecting a stroke simulator separately provided from the housing and the oil passages to each other, a hydraulic source provided inside the housing and configured to discharge brake fluid to an oil passage connected to a hydraulic generation unit mounted on a wheel among the plurality of oil passages, a stroke simulator switching electromagnetic valve provided integrally in the housing, and a control unit provided integrally in the housing and configured to be used to drive the hydraulic source and the stroke simulator switching electromagnetic valve.

In other words, the stroke simulator switching electromagnetic valve is provided integrally in the housing, and therefore this configuration can omit the harness electrically connecting the stroke simulator and the hydraulic control apparatus to each other, thereby preventing or cutting down the cost increase.

(13) The hydraulic control apparatus described in the above-described item (12) further includes a first oil passage at the housing. The first oil passage is configured to supply the brake fluid flowing out of a backpressure chamber of the stroke simulator to the stroke simulator switching electromagnetic valve.

Therefore, this configuration does not require the provision of the pipe connecting the main chamber to which the brake fluid in the stroke simulator flows, and the housing to each other, and therefore can reduce the pipes and thus reduce the cost.

(14) In the hydraulic control apparatus described in the above-described item (13), the housing includes a first surface to which a motor configured to drive the pump is attached, a second surface located opposite from the first surface and having the control unit disposed thereon, a third surface formed continuously from the first surface and the second surface, and a fourth surface formed continuously from the first surface, the second surface, and the third surface. A pipe port to which a pipe leading to the hydraulic generation unit is connected is formed on the third surface. The connection port is formed on the fourth surface.

Therefore, the functions can be distributed to the individual surfaces, and therefore this configuration can prevent or cut down the increase in the size of the housing.

(15) The hydraulic control apparatus described in the above-described item (14) further includes a connector configured to electrically connect the control unit to an external apparatus, and a fifth surface located opposite from the fourth surface. The connector is provided on one side where the fifth surface is located.

The connector, the port, and the like are not provided on the fifth surface, and therefore this configuration can improve workability when a wiring is connected to the connector.

(16) The hydraulic control apparatus described in the above-described item (14) further includes an intake oil passage connecting a reservoir and the housing to each other. The reservoir stores the brake fluid that the hydraulic source draws from the reservoir. The third surface is configured so as to become a top surface when the hydraulic control apparatus is mounted on the vehicle, and is provided with an intake port connected to the intake oil passage.

Therefore, this configuration allows the pipe port and the intake port to be provided on the third surface that will become the top surface, thereby contributing to improvement of the workability of the pipe connection.

(17) The hydraulic control apparatus described in the above-described item (14) further includes an intake oil passage connecting a reservoir and the housing to each other. The reservoir stores the brake fluid that the hydraulic source draws from the reservoir. The pipe port includes a plurality of pipe ports formed along a longitudinal direction of the third surface. The intake port is formed closer to the first surface than the pipe ports are.

The pipe ports and the intake port are disposed offset from each other, and therefore this configuration can realize an efficient layout of the ports and the like, thereby preventing or cutting down the increase in the size of the housing.

(18) A brake system includes a first unit including a stroke simulator configured to generate a reaction force of a brake operation performed by a driver, and a second unit integrally including a hydraulic source configured to generate a hydraulic pressure in a hydraulic generation unit mounted on a wheel, a switching electromagnetic valve configured to be used to permit an inflow of the brake fluid into the stroke simulator, and a control unit configured to be used to drive the hydraulic source and the switching electromagnetic valve.

In other words, the stroke simulator is disposed in the first unit and the switching electromagnetic valve is provided in the second unit. Therefore, this configuration can omit the harness electrically connecting the stroke simulator and the hydraulic control apparats to each other, thereby preventing or reducing the cost increase.

(19) The hydraulic control apparatus described in the above-described item (18) further includes a first oil passage at the housing. The first oil passage is configured to supply the brake fluid flowing out of a backpressure chamber of the stroke simulator to the switching electromagnetic valve.

Therefore, this configuration does not require the provision of the pipe connecting the main chamber to which the brake fluid in the stroke simulator flows, and the housing to each other, and therefore can reduce the pipes and thus reduce the cost.

(20) The hydraulic control apparatus described in the above-described item (19) further includes an oil passage connecting the stoke simulator and the switching electromagnetic valve to each other.

Therefore, the stroke simulator and the switching electromagnetic valve in the second unit can be connected to each other via simple piping.

(21) In the hydraulic control apparatus described in the above-described item (20), the first unit includes the master cylinder including a piston configured to be activated according to a brake pedal operation performed by the driver, and a connection oil passage configured to supply the brake fluid flowing out of the master cylinder to the stroke simulator.

Therefore, the brake fluid in the master cylinder can be absorbed by the stroke simulator.

(22) In the hydraulic control apparatus described in the above-described item (18), the first unit includes a housing. The master cylinder, the stroke simulator, and the connection oil passage are built in the housing.

Therefore, the connection can be established within the first unit, and therefore this configuration does not require the provision of the pipe and the like between the first unit and the second unit, thereby succeeding in reducing the cost.

Having described merely several embodiments of the present invention, those skilled in the art will be able to easily appreciate that the embodiments described as the examples can be modified or improved in various manners without substantially departing from the novel teachings and advantages of the present invention. Therefore, such modified or improved embodiments are intended to be also contained in the technical scope of the present invention. The above-described embodiments may also be arbitrarily combined.

The present application claims priority under the Paris Convention to Japanese Patent Application No. 2015-21684 filed on Feb. 6, 2015. The entire disclosure of Japanese Patent Application No. 2015-21684 filed on Feb. 6, 2015 including the specification, the claims, the drawings, and the abstract is incorporated herein by reference in its entirety.

### REFERENCE SIGN LIST

1 brake system

1a first unit

1b second unit

2 brake pedal

4 reservoir

5 master cylinder

8 wheel cylinder

10P primary pipe

10R connection pipe

10R1 intake port

10S secondary pipe

10wc wheel cylinder pipe

10x backpressure chamber pipe

17 simulator oil passage

20 electromagnetic valve

27 stroke simulator

30 push rod

31 stroke simulator IN valve

32 stroke simulator OUT valve

70 pump

200 housing

201 first surface

201a, 201b master cylinder connection port

202 second surface

202a, 202b front-side mount pin

203 third surface

203a wheel cylinder pipe port

204 fourth surface

204a backpressure chamber port

205 fifth surface

206 sixth surface

206a, 206b lower-side mount pin

250 motor housing

293a wheel cylinder pipe port

300 control unit housing

301 connector portion

302 controller portion

400 mount

510P primary oil passage

510S secondary oil passage

511 simulator oil passage

512 backpressure chamber port

M motor

R1 main chamber

R2 auxiliary chamber

1. A hydraulic control apparatus comprising:
a housing including an oil passage formed therein;
a hydraulic source provided inside the housing and configured to generate a hydraulic pressure in a hydraulic generation unit mounted on a wheel via the oil passage;
a shut-off electromagnetic valve integrally provided in the housing and configured to switch a communication state of the oil passage between a master cylinder provided separately from the housing and the hydraulic generation unit; and
a switching electromagnetic valve provided integrally in the housing and configured to be used to permit an inflow of brake fluid into a stroke simulator, the stroke simulator being configured to generate a reaction force of a brake pedal operation performed by a driver, the stroke simulator being provided separately from the housing; and
a control unit provided integrally in the housing and configured to be used to control and/or drive the hydraulic source, the shut-off electromagnetic valve, and the switching electromagnetic valve.

2. The hydraulic control apparatus according to claim 1, further comprising a first oil passage at the housing, the first oil passage being configured to supply the brake fluid that flows out of a backpressure chamber of the stroke simulator to the switching electromagnetic valve.

3. The hydraulic control apparatus according to claim 2, further comprising a connection port at the housing, the connection port being connected to the first oil passage, the connection port being connected to an oil passage that is connected to the stroke simulator.

4. The hydraulic control apparatus according to claim 3, wherein the housing includes
a first surface to which a motor configured to drive the hydraulic source is attached,
a second surface located opposite from the first surface and having the control unit disposed thereon,
a third surface formed continuously from the first surface and the second surface, and
a fourth surface formed continuously from the first surface, the second surface, and the third surface,
wherein a pipe port to which a pipe leading to the hydraulic generation unit is connected is formed on the third surface, and
wherein the connection port is formed on the fourth surface.

5. The hydraulic control apparatus according to claim 4, further comprising a connector configured to electrically connect the control unit to an external apparatus; and
a fifth surface located opposite from the fourth surface,
wherein the connector is provided on one side where the fifth surface is located.

6. The hydraulic control apparatus according to claim 5, further comprising a sixth surface located opposite from the third surface; and
a mount provided on the sixth surface, the mount being configured to be used to fix the housing to a vehicle.

7. The hydraulic control apparatus according to claim 4, further comprising an intake oil passage that connects a reservoir and the housing to each other,
wherein the reservoir stores the brake fluid which the hydraulic source draws from the reservoir, and
wherein the third surface is configured so as to become a top surface when the hydraulic control apparatus is mounted on the vehicle, and is provided with an intake port connected to the intake oil passage.

8. The hydraulic control apparatus according to claim 4, further comprising an intake oil passage connects a reservoir and the housing to each other, wherein the reservoir stores the brake fluid that the hydraulic source draws from the reservoir;
the hydraulic control apparatus further comprising an intake port provided on the third surface, the intake port being connected to the intake oil passage,
wherein a plurality of pipe ports are formed along a longitudinal direction of the third surface, and
wherein the intake port is formed closer to the first surface than the pipe ports are.

9. The hydraulic control apparatus according to claim 4, wherein a master cylinder connection port to which a master cylinder pipe connected to the master cylinder is connected is formed on the first surface.

10. The hydraulic control apparatus according to claim 9, wherein a second mount portion for fixing the housing to a vehicle is provided on the first surface.

11. The hydraulic control apparatus according to claim 10, wherein a plurality of second mount portions are provided on the first surface.

12. A hydraulic control apparatus comprising:
a housing including a plurality of oil passages formed therein;
a connection port that is formed at the housing, and that connects a stroke simulator and the oil passages to each other, the stroke simulator being separately provided from the housing;
a hydraulic source provided inside the housing and configured to discharge brake fluid to an oil passage connected to a hydraulic generation unit mounted on a wheel among the plurality of oil passages;
a shut-off electromagnetic valve provided integrally in the housing and configured to switch a communication state of the oil passage between a master cylinder provided separately from the housing and the hydraulic generation unit;
a stroke simulator switching electromagnetic valve provided integrally in the housing; and
a control unit provided integrally in the housing and configured to be used to drive the hydraulic source, the shut-off electromagnetic valve, and the stroke simulator switching electromagnetic valve.

13. The hydraulic control apparatus according to claim 12, further comprising a first oil passage at the housing, the first oil passage being configured to supply the brake fluid that flows out of a backpressure chamber of the stroke simulator to the stroke simulator switching electromagnetic valve.

14. The hydraulic control apparatus according to claim 12, wherein the housing includes
a first surface to which a motor configured to drive the hydraulic source is attached,
a second surface located opposite from the first surface and having the control unit disposed thereon,
a third surface formed continuously from the first surface and the second surface, and
a fourth surface formed continuously from the first surface, the second surface, and the third surface,
wherein a pipe port to which a pipe leading to the hydraulic generation unit is connected is formed on the third surface, and wherein the connection port is formed on the fourth surface.

15. The hydraulic control apparatus according to claim 14, further comprising a connector configured to electrically connect the control unit to an external apparatus; and
a fifth surface located opposite from the fourth surface,
wherein the connector is provided on one side where the fifth surface is located.

16. The hydraulic control apparatus according to claim 14, further comprising an intake oil passage that connects a reservoir and the housing to each other,
wherein the reservoir stores the brake fluid that the hydraulic source draws from the reservoir,
wherein the third surface is configured so as to become a top surface when the hydraulic control apparatus is mounted on the vehicle, and is provided with an intake port connected to the intake oil passage.

17. The hydraulic control apparatus according to claim 14, further comprising an intake oil passage that connects a reservoir and the housing to each other,
wherein the reservoir stores the brake fluid that the hydraulic source draws from the reservoir,
wherein a plurality of pipe ports are formed along a longitudinal direction of the third surface, and
wherein the intake port is formed closer to the first surface than the pipe ports are.

18. A brake system comprising:
a first unit including a stroke simulator configured to generate a reaction force of a brake operation performed by a driver; and
a second unit integrally including a hydraulic source configured to generate a hydraulic pressure in a hydraulic generation unit mounted on a wheel, a shut-off electromagnetic valve configured to switch a communication state of an oil passage between a master cylinder provided separately from the first unit and the hydraulic generation unit, a switching electromagnetic valve configured to be used to permit an inflow of the brake fluid into the stroke simulator, and a control unit configured to be used to drive the hydraulic source, and the shut-off electromagnetic valve, and the switching electromagnetic valve.

19. The hydraulic control apparatus according to claim 18, further comprising a first oil passage at the housing, the first oil passage being configured to supply the brake fluid that flows out of a backpressure chamber of the stroke simulator to the switching electromagnetic valve.

20. The brake system according to claim 19, further comprising an oil passage that connects the stoke simulator and the switching electromagnetic valve to each other.

21. The brake system according to claim 20, wherein the first unit includes the master cylinder including a piston configured to be activated according to a brake pedal operation performed by the driver, and a connection oil passage configured to supply the brake fluid that flows out of the master cylinder to the stroke simulator.

22. The brake system according to claim 21, wherein the first unit includes a housing, and
wherein the master cylinder, the stroke simulator, and the connection oil passage are built in the housing.
